(19) United States
(12) Patent Application Publication
(10) Pub. No.: US 2025/0282176 A1
(43) Pub. Date: Sep. 11, 2025

(54) MODIFIED BIDIRECTIONAL CASSETTE SEALS USEFUL IN WHEEL ASSEMBLIES

(71) Applicant: Dale Robert Booms, Harbor Beach, MI (US)

(72) Inventor: Dale Robert Booms, Harbor Beach, MI (US)

(21) Appl. No.: 18/596,828

(22) Filed: Mar. 6, 2024

(51) Int. Cl. B60B 35/04; B60B 27/02; F16J 15/3284

(52) U.S. Cl. CPC B60B 35/04; B60B 27/02; F16J 15/3284; B60B 2360/102; B60B 2380/64; B60B 2900/211; B60B 2900/5112

(57) ABSTRACT

Modified bidirectional cassette seals that are useful in wheel assemblies, especially wheel and track driven farm tractors and includes wagons and other gear subjected to harsh environments such as heavy equipment, such as backhoes, bulldozers and the like.

### TO WHOM IT MAY CONCERN

Be it known that I, Dale Booms, a resident of the City of Harbor Beach, County of Huron, State of Michigan, a citizen of the United States of America has invented new and useful devices that are
MODIFIED BIDIRECTIONAL CASSETTE SEALS USEFUL IN WHEEL ASSEMBLIES
   that are described in this specification.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention with deals new modified and novel bidirectional cassette seals that are useful in wheel assemblies, especially wheel and track driven farm tractors and includes wagons and other gear subjected to harsh environments such as heavy equipment, such as backhoes, bulldozers, and the like.

Traditional prior art seal designs consist of a radial lip, a garter spring and static seal between the outside diameter and housing. The seals represent an increase in the complexity of sealing technology, compared with standard oil mud seal designs.

The improved protection the inventive seals herein provide is the result of the nature of the fluoroelastomer that is used to embed the seal. Also novel is the use of a metal sleeve over the axle on which the seal is to be used. This sleeve enlarges the diameter of the axle.

Known mud block seals are available from SKF (https://www.SKF.com). This invention modifies mud block seals by embedding the iron of the seal in a fluoroelastomer and other high heat elastomers or rubbers to gain heat resistance and other beneficial properties. In addition, there is used a unique metal sleeve around the axle on which the seal is to be used. Mud block seals used in farm equipment or heavy equipment are subjected to harsh environmental conditions, one of which is high temperature operation. Current mud seals cannot last a long time when the operating temperature is in excess of 200° C.

The instant invention can withstand temperatures of up to 300° C. In one test, the prior mud block seal lasted about 400 hours at the high temperature while seals of the instant invention lasted over 4000 hours.

### BRIEF SUMMARY OF THE INVENTION

Thus, this invention deals in one embodiment, a modified bidirectional cassette seal. The seal comprises a metal ring component partially embedded in a fluoroelastomer, the fluoroelastomer being heat resistant up to 300° C. The fluoroelastomer is water, heat and chemical resistant and the seal has an internal diameter of 55 mm to 170 mm and an outside diameter of 80 mm to 200 mm.

In a second embodiment, there is a seal conversion sleeve assembly. The assembly comprises a first metal sleeve, the first metal sleeve being used to increase an outside diameter of a vehicle axle.

There is a modified bidirectional cassette seal as set forth just above that is located in a recess in a second metal sleeve used to decrease an inside diameter wheel hub of a vehicle wheel.

In a third embodiment, there is a wheel assembly. The wheel assembly comprises a vehicle axle having contained thereon a dirt cup. Contained in the dirt cup is a first metal sleeve. The first metal sleeve is insertable into the dirt cup, the first metal sleeve being used to increase an outside diameter of the axle.

A modified bidirectional cassette seal as described Supra is contained in the dirt cup and adjacent to the first metal sleeve. A second metal sleeve used to decrease the inside diameter of a vehicle wheel hub, is inserted in a portion of the dirt cup and adjacent to the modified bidirectional cassette seal.

There is a wheel hub adjacent to a second metal sleeve containing a portion of the second metal sleeve and the second metal sleeve is insertable in a back side of the wheel hub. The back side of the wheel hub contains a first tapered bearing. There is a second tapered bearing inserted in the front side of the wheel hub.

There is a essentially flat head washer adjacent to the second tapered bearing and a tab washer adjacent to the head washer.

There is a threaded bolt having a threaded expanded head threaded into a threaded end of the axle and a threaded nut threaded onto the threaded expanded head.

There is a cup covering the threaded nut and a retainer ring for supporting the cup.

### BRIEF DESCRIPTION OF THE SEVERAL VIEWS OF THE DRAWING(S)

FIG. 1A is a full side view of the second metal sleeve of this invention.

FIG. 1B is a full side view of a modified bidirectional cassette seal of this invention.

FIG. 1C is a full side view of a first metal sleeve of this invention.

FIG. 2 is a full front view of a modified bidirectional cassette seal of this invention.

FIG. 3 is a full back view of the modified bidirectional cassette seal of FIG. 2.

FIG. 4 is a full front view of a first metal sleeve of this invention.

FIG. 5 is a full front view of a sea conversion sleeve assembly of this invention.

FIG. 6 is a full top end view of the device of FIG. 5.

FIG. 7 is a full side view of the fastener of this invention.

FIG. 8 is a full front view of the fastener of FIG. 7.

FIG. 9 is a full front view of a flat washer of this invention.

FIG. 10 is a full side view of the washer in FIG. 9.

FIG. 11 is a full front view of a lock washer of this invention.

FIG. 12 is a full side view of the lock washer of FIG. 11.

FIG. 13 is a full side view of the fastening nut of this invention.

FIG. 14 is a full front view of a fastener of this invention.

FIG. 15 is an exploded view of a portion of a vehicle axle showing the component parts of a wheel assembly of this invention.

### DETAILED DESCRIPTION OF THE INVENTION

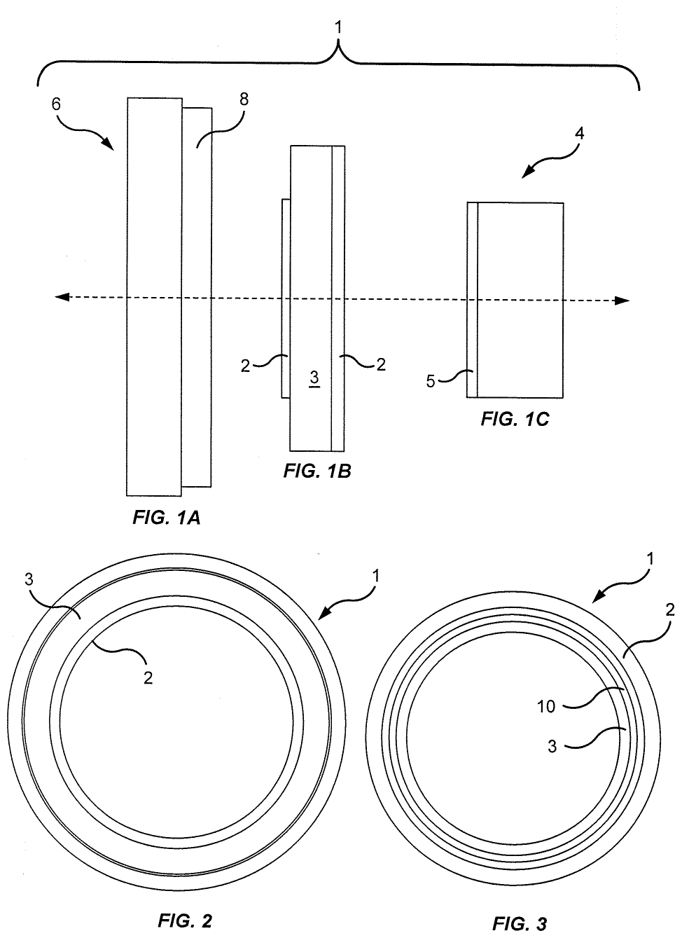

With regard to FIG. 1B, there is shown a modified bidirectional cassette seal 1 of this invention. The seal 1 comprises a metal ring component 2 embedded in an elastomer or rubber matrix 3. The rubber or elastomer is water, heat, and chemical resistant. The elastomer is heat resistant up to 300° C. and is a fluoroelastomer. Preferred for the invention herein is Viton® fluoroelastomer (CH2CF2) n (CF (CF3) CF2) n. For purposes of this invention, the seal 1 has an internal diameter in the range from 55 mm to 170 mm and an outside diameter in the range of from 80 mm to 200 mm.

FIG. 2 is a full front view of the modified bidirectional cassette seal 1 and FIG. 3 is a full back view of the modified bidirectional cassette seal 1. FIG. 3 also shown as small channel 10 in the rubber 3.

Turning now to FIGS. 1A, 1B and 1C, there is shown an exploded view of the seal conversion sleeve assembly 9 of this invention. The assembly 9 comprises a first metal sleeve 6, a combination of a metal ring component 2 partially embedded in an elastomer or rubber section 3, and a second metal sleeve 4. The second metal sleeve 4 is insertable into the back of the elastomer section 3. Note that the second metal sleeve 4 has a chamfered edge 5 on the insertable end. The combination of the rubber section 3 and the second metal sleeve 4 is press fit into the first metal sleeve 6 and this assembly fits into a dirt cup 12 described infra. Note that the first metal sleeve 6 has a reduced diameter back edge 8 which allows the seal 1 to be insertable into a dirt cup 12 described infra. The purpose of the second metal sleeve 4 is to increase an outside diameter of a vehicle axle on which the assembly is used.

FIG. 5 shows a full back view of the assembly 9 showing the second metal sleeve 4, the elastomer section 3, the metal ring 2 and the first metal sleeve 6 all fit together.

FIG. 6 shows a full front view of the assembly 9 showing the second metal sleeve 4, the elastomer section 3, the metal ring 2 and the first metal sleeve 6 all fit together.

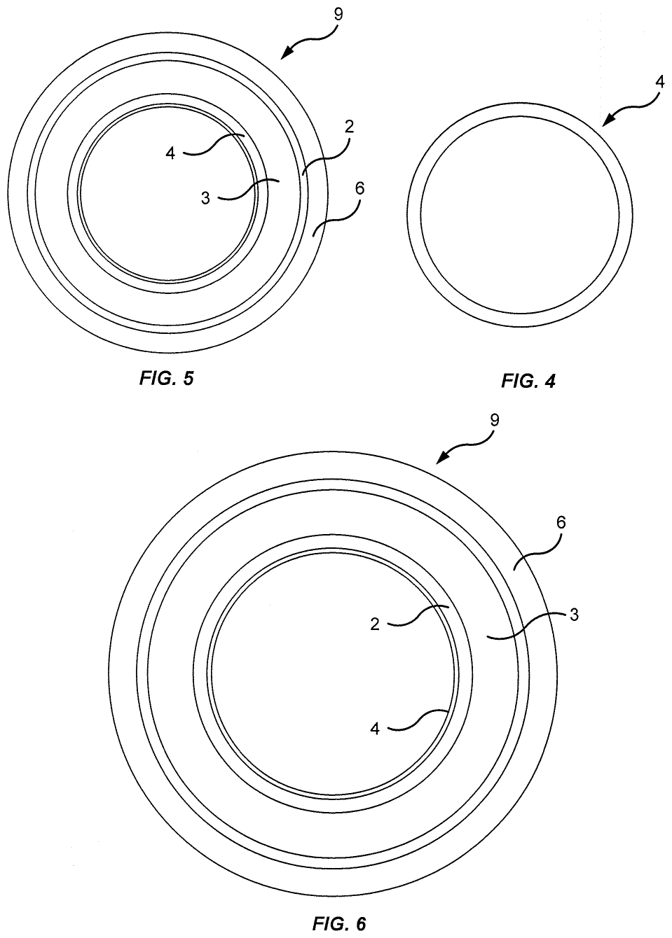

FIG. 4 is a full front view of a second metal sleeve of this invention.

Turning now to FIG. 15, there is shown exploded Figures of the entire wheel assembly apparatus according to this invention. There is shown a portion of a vehicle axle 11, a dirt cup 12, a second metal sleeve 4, a receiver end for a bolt 18, a first tapered bearing 17, the bolt for the receiver 18, a flat washer 19, a tab washer 20, a nut for an enlarged part 7 of the bolt 18, a grease cup 22, and a retainer ring 23.

A dirt cup 12 is placed on the axle 11 and then the combination of the dirt cup 12, the second metal sleeve 4, the seal 1, and the first metal sleeve 6 are placed on the axle 11.

This is followed by a first tapered bearing 15 and then all is covered by the hub 16. Thereafter, there is placed a second tapered bearing 17, a washer 19, a lock washer 20, and a nut 21 which threads on the expanded head 24 of the bolt 18 to hold all of the above-mentioned components in place. There is a cup 22 that can be placed over the nut 21 and it is held in place by a retainer ring 23. By this means, the assembly 9 of this invention can be held in place.

The holding assembly for this invention consisting of the bolt 18, flat washer 19, lock washer 20, and nut 21 can be found in U.S. Pat. No. 11,448,261, that issued on Sep. 20, 2022, in the name of the inventor herein.

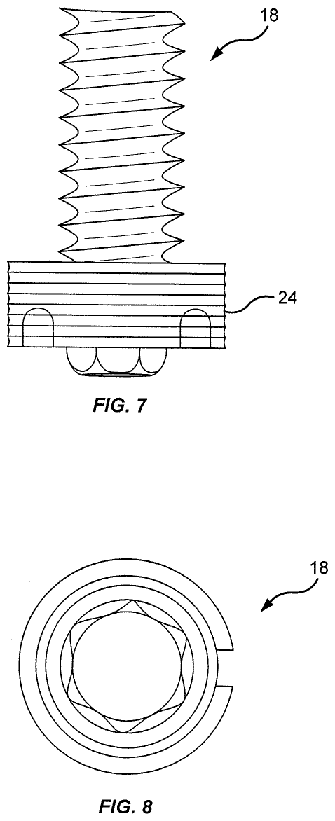

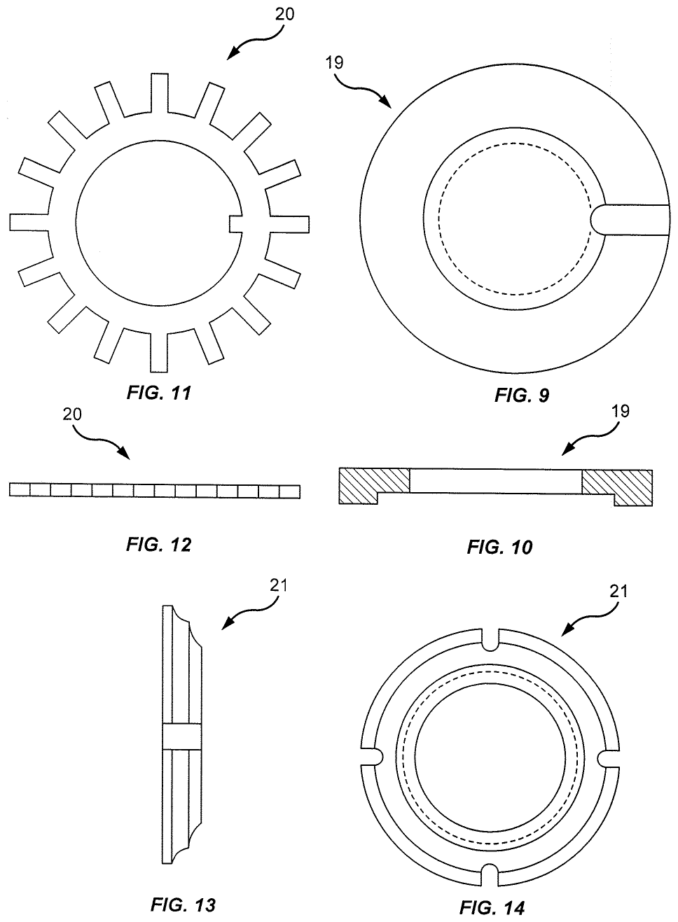

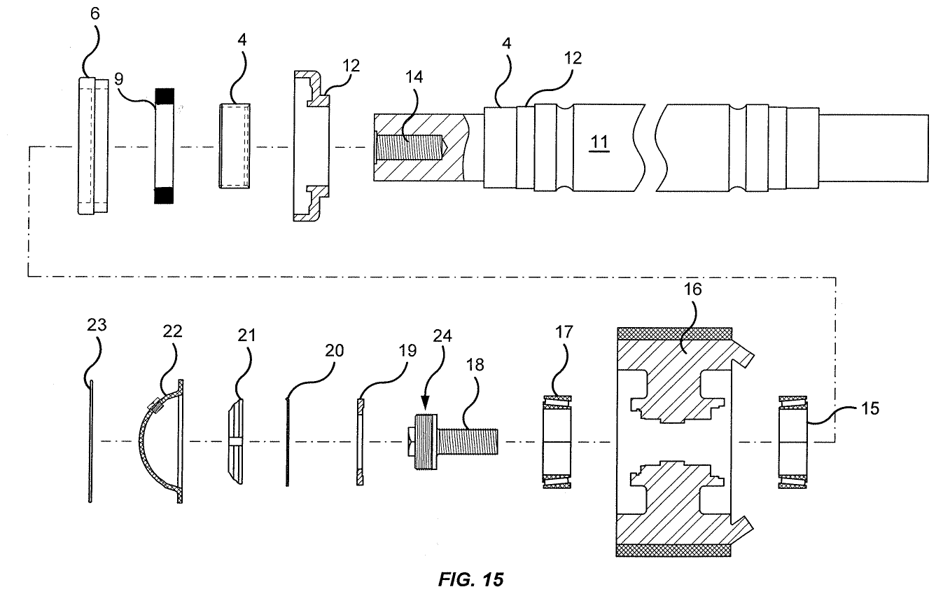

FIGS. 7 and 8 show the bolt 18; FIGS. 9 and 10 show the flat washer 19; FIGS. 11 and 12 show the lock washer 20; FIGS. 13 and 14 show the locking nut 21.

What is claimed is:

1. A modified bidirectional cassette seal, said seal comprising a metal ring component partially embedded in an elastomer, said elastomer being heat resistant up to 300° C.;
said elastomer being water, heat and chemical resistant;
said seal having an internal diameter in the range of 55 mm to 170 mm and an outside diameter in the range of 80 mm to 200 mm.

2. A modified bidirectional cassette seal as claimed in claim 1 wherein said elastomer is a fluoroelastomer.

3. A seal conversion sleeve assembly, said assembly comprising:
A) a first metal sleeve, said metal sleeve being used to increase an outside diameter of a vehicle axle;
B) a modified bidirectional cassette seal as claimed in claim 1 that is located in a recess in
C) a second metal sleeve used to decrease an inside diameter wheel hub of a vehicle wheel.

4. A seal conversion sleeve assembly as claimed in claim 3 wherein the metal is steel.

5. A wheel assembly, said wheel assembly comprising:
A) a vehicle axle having contained thereon a dirt cup;
B) a first metal sleeve, said first metal sleeve being insertable into said dirt cup, said first metal sleeve being used to increase an outside diameter of said axle;
C) a modified bidirectional cassette seal as claimed in claim 1 contained in said dirt cup and adjacent to said metal sleeve;
D) a second metal sleeve used to decrease the inside diameter of a vehicle wheel hub, inserted in a portion of said dirt cup and adjacent to said modified bidirectional cassette seal;
E) a wheel hub adjacent thereto containing a portion of said outer seal insertable in a back side of said wheel hub, said back side of wheel hub containing a first tapered bearing;
F) a second tapered bearing inserted in a front side of said wheel hub;
G) a head washer adjacent said second tapered bearing;
H) a tab washer adjacent said head washer;
I) a threaded bolt having a threaded expanded head threaded into a threaded end of said axle;
J) a threaded nut, threaded onto said threaded expanded head;
K) a cup covering said threaded nut;
L) a retainer ring for supporting said cup.

6. A seal conversion sleeve assembly as claimed in claim 5 wherein the metal is steel.
